(19) United States
(12) Patent Application Publication
(10) Pub. No.: US 2017/0185134 A1
(43) Pub. Date: Jun. 29, 2017

(54) ELECTRONIC DEVICE FOR MANAGING POWER AND METHOD FOR CONTROLLING THEREOF

(71) Applicant: Samsung Electronics Co., Ltd., Gyeonggi-do (KR)

(72) Inventors: Yun Hui HAN, Gyeonggi-do (KR); Chulwoo PARK, Gyeonggi-do (KR); Chi-Hyun CHO, Gyeonggi-do (KR)

(73) Assignee: Samsung Electronics Co., Ltd.

(21) Appl. No.: 15/387,068

(22) Filed: Dec. 21, 2016

(30) Foreign Application Priority Data
Dec. 23, 2015 (KR) 10-2015-0184844

(51) Int. Cl. G06F 1/32; H02J 7/00; H02J 7/02

(52) U.S. Cl. CPC G06F 1/3212; G06F 1/329; H02J 7/025; H02J 7/0052

(57) ABSTRACT

Disclosed is an electronic device and a method for managing power of the electronic device, in which power consumption of the electronic device is controlled based on at least one of a power value which is inputted to or outputted from a power management integrated circuit, such that a pre-designated operating time of the electronic device can be ensured.

### PRIORITY

The present application claims priority under 35 U.S.C. §119 to Korean Patent Application Ser. No. 10-2015-0184844 filed in the Korean Intellectual Property Office on Dec. 23, 2015, the contents of which are incorporated herein by reference.

### BACKGROUND

1. Field of the Disclosure

Embodiments The present disclosure relates generally to an electronic device for managing power and a method for controlling thereof, and more particularly, to an electronic device which can sense power consumption of internal devices configured therein and control used power, and a method for controlling thereof.

2. Description of the Related Art

The recent development of digital technology has brought various electronic devices which can communicate and process personal information while being carried, such as mobile communication terminals, Personal Digital Assistants (PDAs), electronic schedulers, smart phones, tablet Personal Computers (PCs), or the like, into the market. Such electronic devices are miniaturized to increase their portability, and accordingly, their batteries are also miniaturized.

As a small battery is mounted, the electronic device has a limit to its operating time and accordingly there is a need for a method for efficiently managing the power of the electronic device. The electronic device normally includes a Power Management Integrated Circuit (PMIC). The PMIC manages power to be outputted to each piece of hardware of the electronic device.

However, there is no disclosed method for managing power of the electronic device based on power to be outputted to hardware. Accordingly, there is a problem in that the related-art electronic device having a relatively small battery mounted therein has a short operating time.

### SUMMARY

The present disclosure addresses at least the above-mentioned problems and/or disadvantages and provides at least the advantages described below.

Accordingly, an aspect of the present disclosure is to provide an electronic device which controls to change power consumption of the electronic device based on a power value which is measured in at least one power management integrated circuit (PMIC), and a method for controlling thereof.

Another aspect of the present disclosure provides an electronic device which controls power consumption of the electronic device by controlling power applied to internal devices or a running application based on a power value which is measured in a PMIC, and a method for controlling thereof.

Another aspect of the present disclosure provides an electronic device which controls power consumption of the electronic device based on a power value of at least one of an input terminal or an output terminal of a PMIC, and a method for controlling thereof.

According to an aspect of the present disclosure, an electronic device may include a housing, a battery disposed inside the housing, a battery charging device electrically connected to inside of the battery, a plurality of internal devices disposed inside the housing, at least one power control device disposed inside the housing and electrically connected with the internal devices and the battery, wherein the at least one power control device monitors a power value which is provided to the internal devices or consumed in the internal devices, a processor electrically connected with the power control device, and a memory electrically connected with the processor, wherein, when being executed, the memory stores instructions that cause the processor or the power control device to receive an input for designating an operating time during which the electronic device can be operated without being charged, and to change a power consumption value of the internal device when the power value consumed in the internal devices is greater than or equal to a threshold related to the designated operating time.

According to another aspect of the present disclosure, a method for operating of an electronic device may include receiving an input of an operating time during which the electronic device can be operated without being charged, calculating a power threshold related to the operating time based on the operating time and a remaining amount of power of a battery electrically connected to the electronic device, monitoring a power value which is consumed in at least one internal device of the electronic device, and, when the power value consumed in the at least one internal device of the electronic device is greater than or equal to the power threshold, controlling a power consumption value by controlling the at least one internal device.

According to another aspect of the present disclosure, a computer-readable recording medium may store a program for executing a method including receiving an input of an operating time during which the electronic device can be operated without being charged, calculating a power threshold related to the operating time based on the operating time and a remaining amount of power of a battery electrically connected to the electronic device, monitoring a power value which is consumed in at least one internal device of the electronic device, and, when the power value consumed in the at least one internal device of the electronic device is greater than or equal to the power threshold, controlling a power consumption value by controlling the at least one internal device.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates an electronic device in a network environment according to embodiments of the present disclosure;

FIG. 2 is a block diagram of an electronic device according to embodiments of the present disclosure;

FIG. 3 is a block diagram of a program module according to embodiments of the present disclosure;

FIG. 4 is a block diagram of an electronic device 400 according to embodiments of the present disclosure;

FIGS. 5A and 5B are graphs showing an operation of managing power of the electronic device 400 according to embodiments of the present disclosure;

FIG. 6 is a view of a configuration of an electronic device 600 according to embodiments of the present disclosure;

FIG. 7 is a view of a configuration of an electronic device 700 according to embodiments of the present disclosure;

FIG. 8 is a flowchart of a method for managing power in an electronic device according to embodiments of the present disclosure;

FIG. 9 is a flowchart of a method for setting an operating time in an electronic device according to embodiments of the present disclosure;

FIG. 10 shows operating time setting screens according to embodiments of the present disclosure;

FIG. 11 is a flowchart of a method for calculating a power threshold in an electronic device according to embodiments of the present disclosure;

FIG. 12 is a flowchart of a method for sensing a power consumption value in an electronic device according to embodiments of the present disclosure;

FIG. 13 is a flowchart of method for sensing a power consumption value in an electronic device according to embodiments of the present disclosure;

FIG. 14 is a flowchart of a method for sensing a power consumption value in an electronic device according to embodiments of the present disclosure;

FIG. 15 is a flowchart of a method for controlling to change a power consumption value in an electronic device according to embodiments of the present disclosure;

FIG. 16 is a flowchart of a method for controlling to change a power consumption value in an electronic device according to embodiments of the present disclosure;

FIG. 17 is a flowchart of a method for controlling to change a power consumption value in an electronic device according to embodiments of the present disclosure;

FIG. 18 is a flowchart of a method for controlling to change a power consumption value in an electronic device according to embodiments of the present disclosure;

FIG. 19 is a flowchart of a method for controlling power in an electronic device according to embodiments of the present disclosure;

FIGS. 20A and 20B show screens displayed during an operation of controlling running of an application which consumes much power in an electronic device according to embodiments of the present disclosure; and

FIG. 21 is a flowchart of a method for controlling power in an electronic device according to embodiments of the present disclosure.

### DETAILED DESCRIPTION OF EMBODIMENTS OF THE DISCLOSURE

Hereinafter, embodiments of the present disclosure will be explained with reference to the accompanying drawings. However, the present disclosure is not limited to the specific embodiments herein and should be construed as including various modifications, equivalents and/or alternatives of the embodiments of the present disclosure described herein. In the drawings, similar reference numerals may be used for similar elements, steps, components, or the like.

The term “include” is used in the present disclosure to indicate the presence of any listed/named characteristics (for example, numerical values, functions, operations, parts, and the like), and does not preclude the presence of additional characteristics.

The terms “A and/or B,” “at least one of A or/and B,” or “one or more of A or/and B” used in the present disclosure include all possible combinations of the items enumerated therewith. For example, “A and/or B,” “at least one of A and B,” or “at least one of A or B” indicate all of (1) A, (2) B, or (3) both A and B.

The terms such as “first” and “second” may be used in embodiments of the present disclosure to mark/identify/label various elements regardless of the order and/or importance of the elements, and do not limit the marked/identified/labelled elements in any way. These terms are used to distinguish one element from another. For example, unless expressly indicated otherwise, a first element may be referred to as second element, and vice-versa, without departing from the scope and meaning of the present disclosure.

It will be understood that, when an element (for example, a first element) is mentioned as being “operatively or communicatively coupled with/to” or “connected to” another element (for example, a second element), the element may be directly coupled or connected to another element, or there may be an intervening element (for example, a third element) between the element and another element. To the contrary, it will be understood that, when an element (for example, a first element) is mentioned as being “directly coupled” or “directly connected” to another element (for example, a second element), there is no intervening element (for example, a third element) between the element and another element.

The term “configured (or set) to . . . ” used in the embodiments may be interchangeably used with the terms “suitable for . . . ,” “having the capacity to . . . ,” “designed to . . . ,” “adapted to . . . ,” “made to . . . ,” or “capable of . . . ” depending on the situation. The term “configured (or set) to . . . ” does not necessarily mean “specifically designed to . . . ” in a hardware level. Instead, in a certain situation, the term “a device configured to . . . ” may mean “the device being capable of . . . ” with another device or parts. For example, “a processor configured (set) to perform A, B, and C” may mean a dedicated processor (for example, an embedded processor) for performing a corresponding operation, or a generic-purpose processor (for example, a CPU or an application processor) for performing corresponding operations by executing one or more software programs stored in a memory device.

The terms used in the embodiments of the present disclosure are for the purpose of describing specific embodiments only and are not intended to limit the scope of other embodiments. As used herein, the singular forms are intended to include the plural forms as well, unless the context clearly indicates otherwise. All of the terms used herein including technical or scientific terms have the same meanings as those generally understood by an ordinary skilled person in the related art unless they are defined otherwise. The terms defined in a generally used dictionary should be interpreted as having the same meanings as the contextual meanings of the relevant technology and should not be interpreted as having ideal or exaggerated meanings unless they are clearly defined in the embodiments. According to circumstances, the terms defined in the embodiments should not be interpreted as excluding the embodiments of the present disclosure.

An electronic device as used in the present disclosure may include at least one of a smartphone, a tablet personal computer (PC), a mobile phone, a video phone, an electronic book reader, a desktop PC, a laptop PC, a netbook computer, a workstation, a server, a personal digital assistant (PDA), a portable multimedia player (PMP), an motion pictures experts group (MPEG) layer audio 3 (MP3) player, a mobile medical machine, a camera, or a wearable device (for example, smart glasses, a head-mounted-device (HMD), electronic clothing, an electronic bracelet, an electronic necklace, an electronic appcessory, electronic tattoos, a smart mirror, or a smartwatch).

According to an embodiment, the electronic device may be a smart home appliance. For example, the smart home appliance may include at least one of a television, a digital versatile disk (DVD) player, an audio device, a refrigerator, an air conditioner, a cleaner, an oven, a microwave oven, a washing machine, an air cleaner, a set-top box, a home automation control panel, a security control panel, a TV box (for example, Samsung HomeSync™, Apple TV™, or Goggle TV™), a game console (for example, Xbox™, PlayStation™), an electronic dictionary, an electronic key, a camcorder, or an electronic picture frame.

According to another embodiment, the electronic device may include at least one of various medical machines (for example, various portable medical measurement devices (a blood glucose monitoring device, a heart rate monitor, a blood pressure measuring device, or a thermometer), magnetic resonance angiography (MRA), magnetic resonance imaging (MRI), computerized tomography (CT), a tomograph, an ultrasound machine, and the like), a navigation device, a global positioning system (GPS) receiver, an event data recorder (EDR), a flight data recorder (FDR), an automotive infotainment device, electronic equipment for ship (for example, a navigation equipment for ship, a gyro compass, and the like), avionics, a security device, a head unit for vehicle, an industrial or home robot, an automatic teller's machine of a financial institution, a point of sales (POS) device, or Internet of things (IoT) device (for example, a light bulb, various sensors, an electricity or gas meter, a sprinkler device, a fire alarm, a thermostat, a streetlamp, a toaster, fitness equipment, a hot water tank, a heater, a boiler, or the like).

According to an embodiment, the electronic device may include at least one of a part of furniture or a building/a structure, an electronic board, an electronic signature receiving device, a projector, and various measurement devices (for example, water, power, gas, radio waves, and the like). The electronic device may be one or a combination of one or more of the above-mentioned devices. In an embodiment, the electronic device may be a flexible electronic device. In addition, the electronic device according to embodiments of the present disclosure is not limited to the above-mentioned devices and may include a new electronic device with the advancement of technology.

Hereinafter, an electronic device according to embodiments will be explained with reference to the accompanying drawings. The term “user” used in the embodiments may refer to a person who uses the electronic device or a device that uses the electronic device (for example, an artificial intelligence electronic device).

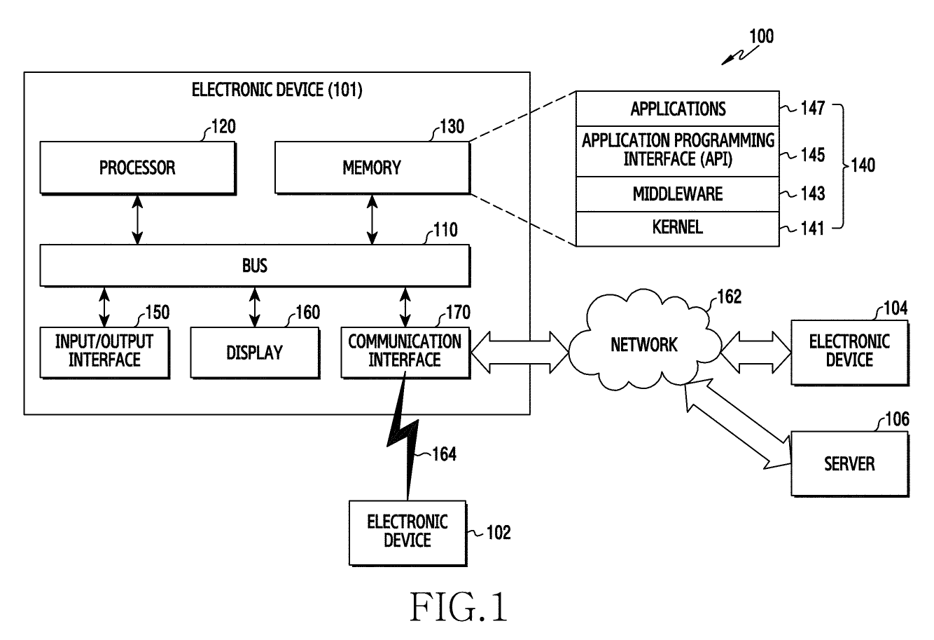

Referring to FIG. 1, an electronic device 101 in a network environment 100 according to embodiments of the present disclosure is described. The electronic device 101 may include a bus 110, a processor 120, a memory 130, an input and output interface 150, a display 160, and/or a communication interface 170. In a certain embodiment, the electronic device 101 may omit at least one of the elements or may additionally include other elements.

The bus 101 may include a circuit which connects the elements 120-170 with one another and delivers communication (for example, a control message and/or data) between the elements.

The processor may 120 include one or more of a central processing unit (CPU), an application processor (AP), and a communication processor (CP). The processor 120 may perform calculation or data processing related to control and/or communication of at least one other element of the electronic device 101.

The memory 130 may include a volatile memory and/or a non-volatile memory. For example, the memory 130 may store commands or data related to at least one other element of the electronic device 101. According to an embodiment, the memory 130 may store software and/or a program 140. The program 140 may include a kernel 141, middleware 143, an application programming interface (API) 145, and/or applications 147, or the like. At least two of the kernel 141, the middleware 143, or the API 145 may be referred to as an operating system (OS).

For example, the kernel 141 may control or manage system resources which are used for performing operations or functions implemented in the other programs. In addition, the kernel 141 may provide an interface for allowing the middleware 143, the API 145, or the application program 147 to access an individual element of the electronic device 101 and control or manage the system resources.

For example, the middleware 143 may serve as an intermediary to allow the API 145 or the application program 147 to communicate and exchange data with the kernel 141. In addition, the middleware 143 may perform scheduling or load balancing) with respect to work requests received from the application program 147, for example, by giving priority to use the system resources of the electronic device 101 to at least one application of the application program 147.

For example, the API 145 may be for allowing the application 147 to control a function provided by the kernel 141 or the middleware 143, and, for example, may include at least one interface or instructions for controlling a file, controlling a window, processing an image, or controlling a text.

For example, the input and output interface 150 may serve as an interface for transmitting instructions or data inputted by the user or another external device to other element(s) of the electronic device 101. In addition, the input and output interface 150 may output instructions or data received from other element(s) of the electronic device 101 to the user or another external device.

For example, the display 160 may include a liquid crystal display (LCD), a light emitting diode (LED) display, an organic LED (OLED) display, a micro electro mechanical system (MEMS) display, or an electronic paper display. For example, the display 160 may display various contents (for example, a text, an image, a video, an icon, or a symbol) for the user. The display 160 may include a touch screen, and for example, may receive a touch, a gesture, an approach, or a hovering input inputted using an electronic pen or a part of a user's body.

For example, the communication interface 170 may set communication between the electronic device 101 and an external device, such as a first external electronic device 102, a second external electronic device 104, or a server 106. For example, the communication interface 170 may be connected to a network 162 through wireless communication or wire communication to communicate with an external device.

The wireless communication may use, as a cellular communication protocol, at least one of long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM). For example, the wire communication may include at least one of a universal serial bus (USB), a high definition multimedia interface (HDMI), recommended standard 232 (RS-232), or plain old telephone service (POTS). The network 162 may include a telecommunications network, such as at least one of a computer network (for example, a local area network (LAN) or a wide area network (WAN)), the Internet, or a telephone network.

The first and second external electronic devices 102 and 104 may be the same or different kind of device as or from the electronic device 101. According to an embodiment, the server 106 may include a group of one or more servers.

According to embodiments, an entirety or part of operations performed in the electronic device 101 may be performed in another electronic device or a plurality of electronic devices. When the electronic device 101 should perform a certain function or service automatically or according to a request, the electronic device 101 may request another device to perform at least some of the related functions additionally or instead of performing the function or the service by itself. Another device may perform the requested function or additional function and may deliver the result thereof to the electronic device 101. The electronic device 101 may process the received result as it is or additionally and provide the requested function or service. To achieve this, technologies such as cloud, distributed, or client-server computing may be used.

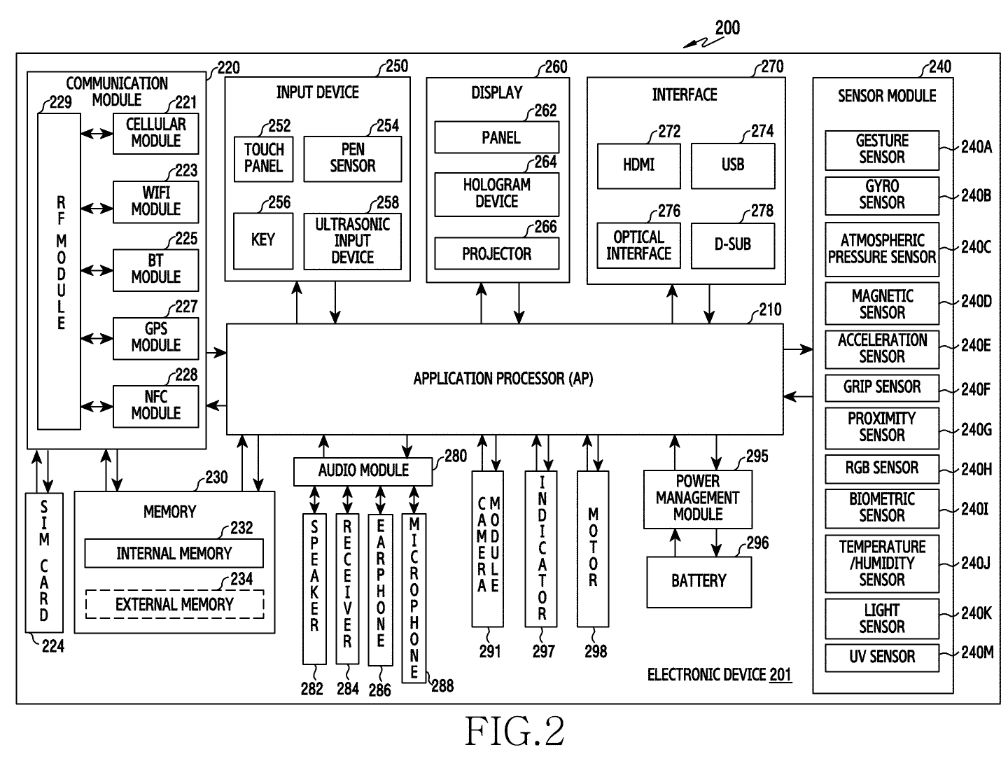

FIG. 2 illustrates a block diagram 200 of an electronic device 201 according to embodiments of the present disclosure. For example, the electronic device 201 may include all or part of the electronic device 101 shown in FIG. 1. The electronic device 201 may include one or more application processors (APs) 210, a communication module 220, a subscriber identification module (SIM) card 224, a memory 230, a sensor module 240, an input device 250, a display 260, an interface 270, an audio module 280, a camera module 291, a power management module 295, a battery 296, an indicator 297, or a motor 298.

The AP 210 may control a plurality of hardware or software elements connected to the AP 210 by driving an operating system or an application program, and may process and calculate a variety of data. For example, the AP 210 may be implemented by using a system on chip (SoC) and may further include a graphic processing unit (GPU) and/or an image signal processor. The AP 210 may include at least part of the elements shown in FIG. 2, such as the cellular module 221. The AP 210 may load instructions or data received from a non-volatile memory into a volatile memory and process the instructions or data, and may store various data in the non-volatile memory.

The communication module 220 may have a same or similar configuration as or to that of the communication interface 170 of FIG. 1. For example, the communication module 220 may include a cellular module 221, a WiFi module 223, a BT module 225, a GPS module 227, an NFC module 228, and a radio frequency (RF) module 229.

The cellular module 221 may provide a voice call, a video call, a text service, or an Internet service through a telecommunications network. According to an embodiment, the cellular module 221 may identify and authenticate the electronic device 201 in the telecommunications network by using the SIM card 224. T cellular module 221 may perform at least some of the functions provided by the AP 210, and may include a communication processor (CP).

The WiFi module 223, the BT module 225, the GPS module 227, or the NFC module 228 each may include a processor for processing data received and transmitted through a corresponding module. According to an embodiment, at least two of these modules may be included in a single integrated chip (IC) or a single IC package.

The RF module 229 may transmit and receive communication signals such as RF signals. For example, the RF module 229 may include a transceiver, a power amp module (PAM), a frequency filter, a low noise amplifier (LNA), or an antenna. According to another embodiment, at least one of the cellular module 221, the WiFi module 223, the BT module 225, the GPS module 227, or the NFC module 228 may transmit and receive an RF signal through a single separate RF module.

The SIM card 224 may include a card and/or an embedded SIM including a subscriber identification module, and may include its unique identification information, such as an integrated circuit card identifier (ICCID) or subscriber information, such as international mobile subscriber identity (IMSI)).

The memory 230 may include an internal memory 232 or an external memory 234. For example, the internal memory 232 may include at least one of a volatile memory (for example, a dynamic random access memory (DRAM), a static random access memory (SRAM), or a synchronous DRAM (SDRAM)) and a non-volatile memory (for example, a one-time programmable read only memory (OTPROM), a programmable read only memory (PROM), an erasable programmable read only memory (EPROM), an electrically erasable programmable read only memory (EEPROM), a mask ROM, a flash ROM, a flash memory (for example, a NAND or a NOR flash memory), a hard drive, and a solid state drive (SSD).

For example, the external memory 234 may further include a flash drive, for example, compact flash (CF), secure digital (SD), micro-SD, Mini-SD, extreme-digital (xD), or a memory stick. The external memory 234 may be functionally and/or physically connected with the electronic device 201 through various interfaces.

The sensor module 240 may measure a physical quantity or detect an operation state of the electronic device 201, and may convert measured or detected information into electric signals. The sensor module 240 may include at least one of a gesture sensor 240A, a gyro sensor 240B, a barometric pressure sensor 240C, a magnetic sensor 240D, an acceleration sensor 240E, a grip sensor 240F, a proximity sensor 240G, a color sensor 240H (for example, red, green, blue (RGB) sensor), a biosensor 2401, a temperature/humidity sensor 240J, an illuminance sensor 240K, and a ultraviolet (UV) sensor 240M. Additionally or alternatively, the sensor module 240 may include an E-nose sensor, an electromyography (EMG) sensor, an electroencephalogram (EEG) sensor, an electrocardiogram (ECG) sensor, an infrared ray (IR) sensor, an iris sensor, and/or a fingerprint sensor. The sensor module 240 may further include a control circuit to control at least one sensor included therein. According to an embodiment, the electronic device 201 may further include a processor configured to control the sensor module 240 as a part of the AP 210 or a separate part, and may control the sensor module 240 while the AP 210 is in a sleep state.

The input device 250 may include a touch panel 252, a (digital) pen sensor 254, a key 256, or an ultrasonic input device 258. The touch panel 252 may use at least one method of capacitive, resistive, infrared, and ultrasonic methods. In addition, the touch panel 252 may further include a control circuit. The touch panel 252 may further include a tactile layer to provide a tactile response to the user.

The (digital) pen sensor 254 may be a part of the touch panel or may include a separate sheet for recognition. The key 256 may include a physical button, an optical key, or a keypad. The ultrasonic input device 258 may allow the electronic device 201 to detect sound waves through a microphone 288 through an input device generating ultrasonic signals, and may identify data.

The display 260 may include a panel 262, a hologram device 264, or a projector 266. The panel 262 may include a same or similar configuration as or to that of the display 160 of FIG. 1, may be implemented to be flexible, transparent, or wearable, and may be configured as a single module along with the touch panel 252. The hologram device 264 may show a stereoscopic image in the air using interference of light. The projector 266 may display an image by projecting light onto a screen. The screen may be located inside or outside the electronic device 201. According to an embodiment, the display 260 may further include a control circuit to control the panel 262, the hologram device 264, or the projector 266.

The interface 270 may include a high definition multimedia interface (HDMI) 272, a universal serial bus (USB) 274, an optical interface 276, or d-subminiature (D-sub) 278. The interface 270 may be included in the communication interface 170 shown in FIG. 1. Additionally or alternatively, the interface 270 may include a mobile high definition link (MHL) interface, a secure digital (SD) card/multimedia Card (MMC) interface or infrared data association (IrDA) standard interface.

The audio module 280 may convert a sound and an electric signal bidirectionally. For example, at least some elements of the audio module 280 may be included in the input and output interface 150 shown in FIG. 1. The audio module 280 may process sound information which is inputted or outputted through a speaker 282, a receiver 284, an earphone 286, or the microphone 288.

The camera module 291 is for capturing a still image and a moving image, and, according to an embodiment, the camera module 291 may include one or more image sensors such as a front or rear surface sensor, a lens, an image signal processor (ISP), or a flash (for example, a light emitting diode (LED) or a xenon lamp).

The power management module 295 may manage power of the electronic device 201. According to an embodiment, the power management module 295 may include a power management integrated circuit (PMIC), a charger IC, or a battery gauge. For example, the PMIC may have a wire charging method and/or a wireless charging method. The wireless charging method may include a magnetic resonance method, a magnetic induction method, or an electromagnetic wave method, and an additional circuit for charging wirelessly, for example, a coil loop, a resonant circuit, a rectifier, and the like may be added. For example, the battery gauge may measure a state of charging of the battery 296, a voltage, a current, or temperature during charging. The battery 296 may include a rechargeable battery and/or a solar battery.

The indicator 297 may display a specific state of the electronic device 201 or a part such as the AP 210, for example, a booting state, a message state, or a charging state. The motor 298 may convert an electric signal into a mechanical vibration, and cause a vibration or haptic effect. The electronic device 201 may include a processing device for supporting a mobile TV, which may process media data according to standards such as digital multimedia broadcasting (DMB), digital video broadcasting (DVB), or media flow.

Each of the above-described elements of the electronic device may include one or more components, and the names of the elements may vary according to the type of the electronic device. In embodiments, the electronic device may include at least one of the above-described elements, and some of the elements may be omitted or an additional element may be further included. In addition, some of the elements of the electronic device according to embodiments may be combined into a single entity, and may perform the same functions as those of the elements before being combined.

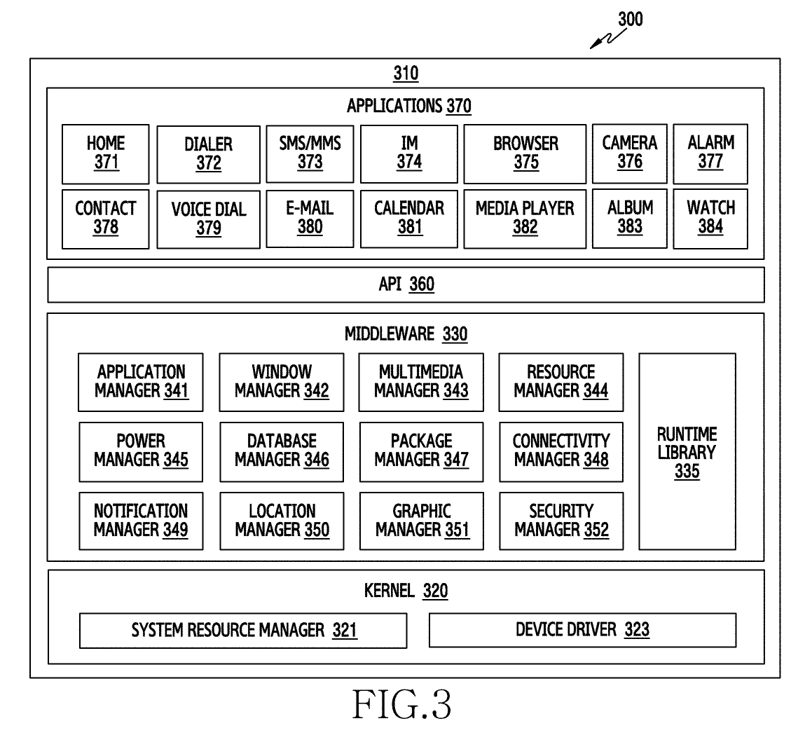

FIG. 3 illustrates a block diagram 300 of a program module 310 according to embodiments. According to an embodiment, the program module 310 may include an OS for controlling resources related to an electronic device and/or various applications driven on the OS. For example, the OS may be Android™, iOS™, Windows™, Symbian™, Tizen™, or Bada™.

The program module 310 may include a kernel 320, middleware 330, an application programming interface (API) 360, and/or applications 370. At least part of the program module 310 may be preloaded on the electronic device or downloaded from an external electronic device.

The kernel 320 may include a system resource manager 321 and/or a device driver 323. The system resource manager 321 may control, allocate or collect the system resources. According to embodiments, the system resource manager 321 may include a process manager, a memory manager, and a file system manager. The device driver 323 may include a display driver, a camera driver, a Bluetooth® driver, a shared memory driver, a USB driver, a keypad driver, a WiFi driver, an audio driver, or an inter-process communication (IPC) driver, for example.

The middleware 330 may provide functions which are commonly required by the applications 370 or may provide various functions to the applications 370 through the API 360 such that the applications 370 can effectively use limited system resources in the electronic device. According to embodiments, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

For example, the runtime library 335 may include a library module which is used by a compiler to add a new function through a programming language while at least one of the applications 370 is running The runtime library 335 may perform functions on input/output management, memory management, and an arithmetic function.

The application manager 341 may manage a life cycle of at least one of the applications 370, for example. The window manager 342 may manage GUI resources used in a screen. The multimedia manager 343 grasps a format necessary for reproducing various media files and encodes or decodes the media files by using a Codec suited to the corresponding format. The resource manager 344 may manage resources such as a source code, a memory, or a storage space of at least one of the applications 370.

The power manager 345 may operate along with a basic input/output system (BIOS) to manage a battery or power and provide power information necessary for operations of the electronic device. The database manager 346 may generate, search, or change a database which is used in at least one of the applications 370. The package manager 347 may manage installing or updating of an application which is distributed in the form of a package file.

The connectivity manager 348 may manage wireless connection of WiFi and Bluetooth, for example. The notification manager 349 may display an event such as a message arrived, an appointment, a notification of proximity in such a manner that the event does not hinder the user. The location manager 350 may manage location information of the electronic device. The graphic manager 351 may manage a graphic effect to be provided to the user or a relevant user interface. The security manager 352 may provide an overall security function necessary for system security or user authentication. According to embodiments, when the electronic device is equipped with a telephony function, the middleware 330 may further include a telephony manager to manage a speech or video telephony function of the electronic device.

The middleware 330 may include a middleware module to form a combination of the various functions of the above-described elements, and may provide a module which is customized according to a type of OS to provide a distinct function. In addition, the middleware 330 may dynamically delete some of the existing elements or may add new elements.

The API 360 is a set of API programming functions and may be provided as a different configuration according to an OS. For example, in the case of Android™ or IOS™, a single API set may be provided for each platform. In the case of Tizen™, two or more API sets may be provided for each platform.

The applications 370 may include one or more applications for providing functions, such as a home 371, a dialer 372, a short message service (SMS)/multimedia messaging service (MMS) 373, an instant message (IM) 374, a browser 375, a camera 376, an alarm 377, contacts 378, a voice dial 379, an email 380, a calendar 381, a media player 382, an album 383, or a clock 384, or health care, such as measuring exercise or blood glucose, or providing environmental information, such as information on atmospheric pressure, humidity, or temperature.

According to embodiments, the applications 370 may include an information exchange application for supporting information exchange between the electronic device and an external electronic device. The information exchange application may include a notification relay application for relaying specific information to an external electronic device or a device management application for managing an external electronic device.

For example, the notification relay application may include a function of relaying notification information generated by other applications of the electronic device to an external electronic device, may receive notification information from an external electronic device, and may relay the same to the user.

For example, the device management application may install, delete or update at least one function of an external electronic device communicating with the electronic device, an application operating in the external electronic device or a calling or message service provided by the external electronic device.

According to embodiments, the applications 370 may include an application which is specified according to the attribute of an external electronic device, may include an application received from an external electronic device, and may include a preloaded application or a third party application which may be downloaded from a server. The names of the elements of the program module 310 according to the illustrated embodiments may be changed according to a type of OS.

According to embodiments, at least part of the program module 310 may be implemented by all or at least two of software, firmware, and hardware. At least part of the program module 310 may be executed by a processor, and may include a module, a program, a routine, sets of instructions, or a process to perform one or more functions, for example.

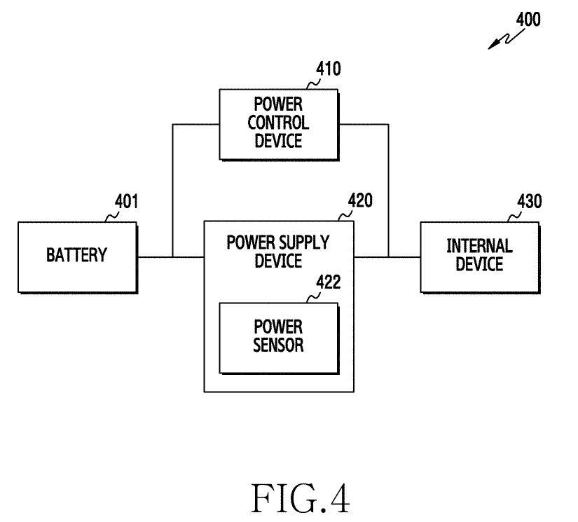

FIG. 4 illustrates a block diagram to describe an electronic device 400 according to embodiments of the present disclosure. The electronic device 400 may be the electronic device 101 or the electronic device 201.

According to embodiments, the electronic device 400 may include a battery 401, a power control device 410, a power supply device 420, and internal devices 430.

The battery 401 may provide power to the inner devices 430 of the electronic device 400, such as hardware including a processor, a camera, a display, and a communication module. According to an embodiment, the battery 401 may include a rechargeable battery and/or a solar battery. The battery 401 is attachable to or detachable from the electronic device 400. However, this is merely an example and the battery 401 may be connected with the electronic device 400 to provide power to the internal devices 430 of the electronic device 400.

The power supply device 420 may manage power inputted from the battery 401 and output the power to the internal devices 430 of the electronic device 400. According to embodiments, the power supply device 420 may provide power inputted from the battery 401 to at least some of the internal devices 430 of the electronic device 400 or at least some of sub internal devices (for example, sub hardware) configured in the internal devices 430. For example, when all of the internal devices 430 of the electronic device 400 are not used and only some of the internal devices 430 are operated, the power supply device 420 may provide power from the battery 401 only to at least some of the internal devices 430 that are requested to operate, and may not provide power to the other internal devices 430. In addition, the power supply device 420 may regulate power and provide the regulated power to at least some of the internal devices 430 (for example, a processor).

According to embodiments, the power supply device 420 may include a power sensor 422. This is merely a configuration according to an embodiment, and the power sensor 422 may be separated from the power supply device 420. For example, the power sensor 422 may be an independent configuration or a configuration which is included in other configurations.

According to embodiments, the power sensor 422 may sense a power value which is inputted to the power supply device 420, may sense a power value which is outputted from the power supply device 420, may include at least one means for sensing a current value which is inputted to the power supply device 420 or a current value which is outputted from the power supply device 420, and may further include at least one means for sensing a voltage value which is inputted to the power supply device 420 or a voltage value which is outputted from the power supply device 420. When the power sensor 422 includes a calculation module, the power sensor 422 may obtain at least one of a power value which is inputted to the power supply device 420 or a power value which is outputted from the power supply device 420 by calculating the sensed current value and the sensed voltage value. According to another embodiment, the power sensor 422 may provide the sensed current value and the sensed voltage value to another configuration, such as the power control device 410, such that another configuration processes to calculate at least one of the power value inputted to the power supply device 420 or the power value outputted from the power supply device 420.

According to embodiments, the power value outputted from the power supply device 420 may be a power value which is inputted to the internal devices 430 of the electronic device 400. The power sensor 422 may measure a power value for each of the rails (for example, a power supply rail) connected to the power supply device 420 and the internal devices 430.

According to embodiments of the present disclosure, the power sensor 422 may sense at least one of the power value and the current value by sampling a signal inputted from the battery 401.

According to embodiments, the power supply device 420 may include a regulator to regulate at least part of the power received from the battery 401, and may include a PMIC.

The power control device 410 may calculate a power threshold meaning an amount of power which can be consumed in the electronic device 400 during a pre-designated operating time, based on current power remaining in the battery 401. The operating time may be a time during which the electronic device 400 should be operated without charging the battery 401, and may be designated based on a user's input, such as a voice, a key, or a gesture input. According to embodiments, the power control device 410 may calculate the power threshold based on a calculation method of dividing the remaining power of the battery 401 by the operating time.

According to embodiments, the power control device 410 may obtain the power value inputted to the power supply device 420 from the battery 401 from the power sensor 422, and may compare the power value and the calculated power threshold. The power control device 410 may determine whether the obtained power value is greater than or equal to the power threshold, and may generate a control signal for controlling the power supply device 420 and at least one internal device 430 based on at least part of the determination.

For example, when a power consumption value received from the internal device 430 is greater than or equal to the power threshold, the power control device 410 may generate a control signal for limiting at least part of power consumption. According to an embodiment, the control signal may include at least one of information for controlling at least some functions of at least one internal device 430, information for controlling at least some functions of an application run by the internal device 430, or information for adjusting the amount of power supplied from the power supply device 420 to at least one internal device 430.

According to embodiments, based on the control signal generated by the power control device 401, the power supply device 420 or at least one of the internal devices 430 may adjust the power value which is consumed by the electronic device 400. In certain examples, based on the control signal, the power supply device 420 may control the current value related to the power supply rail for connecting the power supply device 420 and the internal devices 430, at least one internal device 430 may limit the operation of at least one internal device 430 which consumes power more than the pre-designated threshold, and at least one internal device 430 may control the operation of an application which consumes power more than the pre-designated threshold. As described above, the electronic device 400 controls the power of the power supply device 420 or at least some of the internal devices 430 so as not to consume power more than the power threshold, such that the operating time of the electronic device 400 can be ensured as much as the pre-designated operating time.

According to embodiments, the power control device 410 may further include at least one of a register which stores the current value and the voltage value for calculating the power value, or a register which stores the power value which is a result of the calculating. The register for storing the current value and the voltage value for calculating the power value or the power value which is the result of the calculating according to embodiments may be included in the power supply device 420.

According to embodiments, at least one of the power control device 410 or the power supply device 430 may be included in a charging circuit.

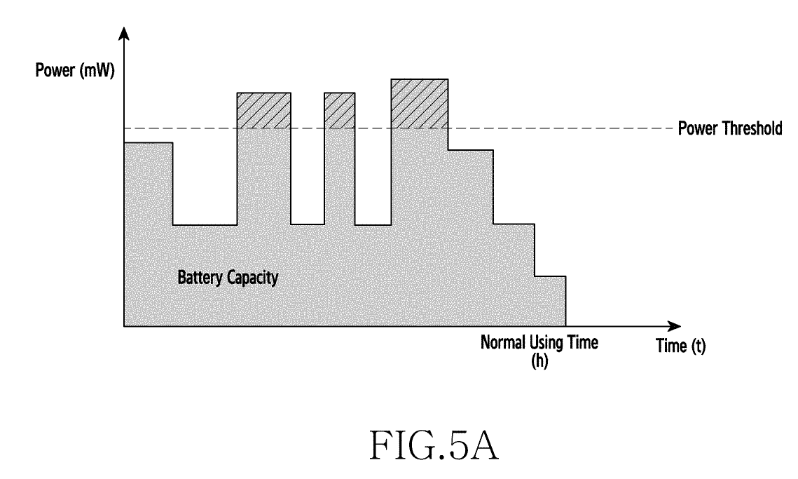

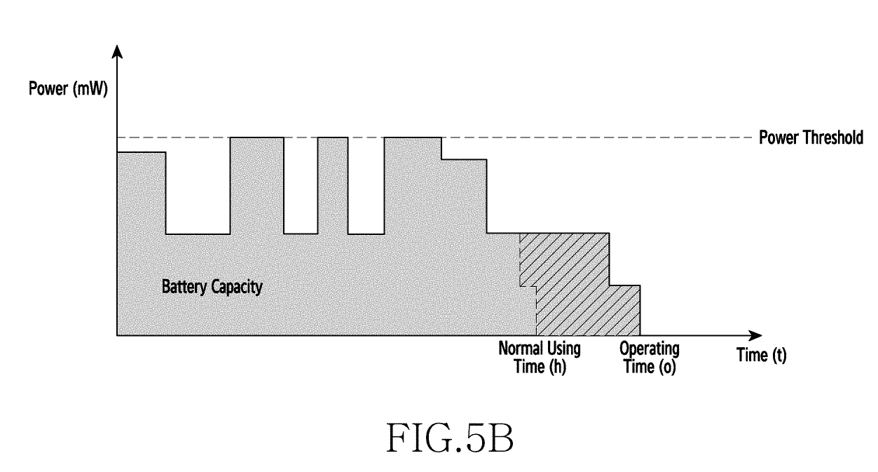

FIGS. 5A and 5B are graphs describing an operation of managing power of the electronic device 400 according to embodiments of the present disclosure.

As shown in FIG. 5A, when an operating time (o) during which the electronic device 400 should be operated without charging the battery 401 is not set, the electronic device 400 may be operated during a normal using time (h) during which the electronic device 400 can be operated with the remaining amount of power of the battery 401.

When the operating time (o) of the electronic device 400 is set as shown in FIG. 5B, the electronic device 400 may prevent power from being consumed more than a power threshold and thereby may be operated until the end of the designated operating time (o). For example, the electronic device 400 may be operated until the end of the designated operating time (o) beyond the normal using time (h), during which the electronic device 400 can be operated with the remaining amount of power of the battery 401. According to an embodiment, the power threshold may be determined with reference to a user's using pattern or an average amount of used power, and may be dynamically determined based on the state of the electronic device 400, such as use of an application or network, or display brightness.

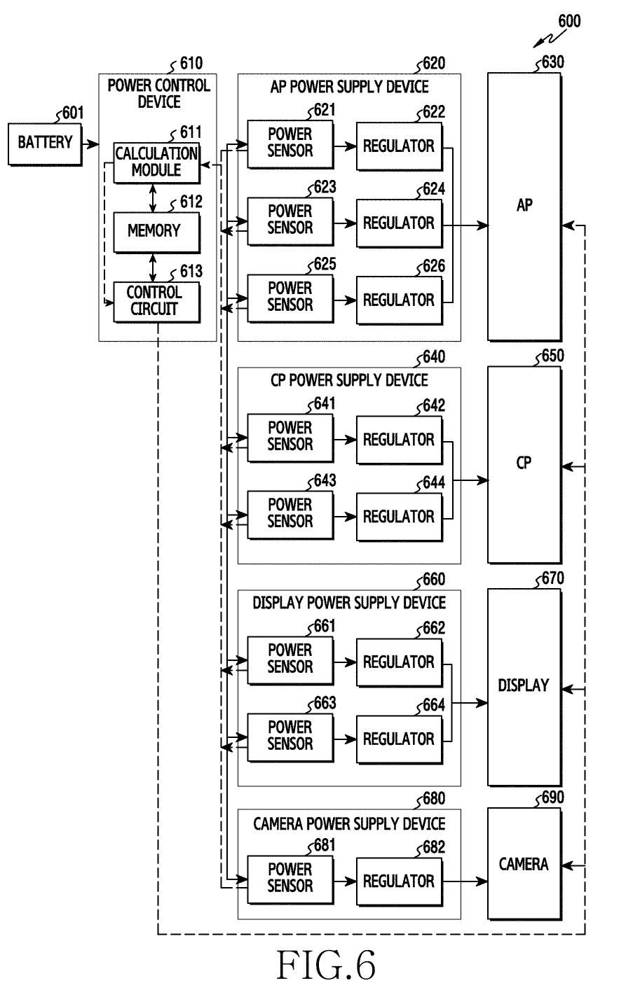

FIG. 6 illustrates a view showing a configuration of an electronic device 600 according to embodiments of the present disclosure. The electronic device 600 may be the electronic device 101, the electronic device 201, or the electronic device 400.

As shown in FIG. 6, the electronic device 600 may include a battery 601, a power control device 610, an AP power supply device 620, an AP 630, a CP power supply device 640, a CP 650, a display power supply device 660, a display 670, a camera power supply device 680, and a camera 690. In FIG. 6, the electronic device 600 includes the AP 630, the CP 650, the display 670, and the camera 690 as hardware to which the electronic device 600 provides power. However, one of ordinary skill in the art would understand that this is merely an example. In FIG. 6, lines for connecting the elements may include a power path and a control path for forwarding signals or information for controlling, such as an inter-integrated circuit (I2C) or a serial interface, and the paths for transferring power are expressed by solid lines and the paths for transferring signals or information are expressed by dashed lines for the convenience of explanation.

The battery 601 may include a rechargeable battery and/or a solar battery.

The AP power supply device 620, the CP power supply device 640, the display power supply device 660, and the camera power supply device 680 may output power which is inputted from the battery 601 to their respective hardware, and may be referred to as sub power supply devices. In addition, each of the sub power supply devices may include at least one sensor for measuring at least one of power values inputted thereto.

For example, the AP power supply device 620 may include at least one sensor 621, 623, 625 for sensing a power value consumed in the AP power supply device 620. According to an embodiment, the power value consumed in the AP power supply device 620 may include a power value which is inputted to the AP power supply device 620. According to another embodiment, the power value consumed in the AP power supply device 620 may include a power value which is outputted from the AP power supply device 620. The at least one sensor 621, 623, 625 may sense the power value inputted to the AP power supply device 620 and output a result of the sensing to the power control device 610. In addition, the at least one sensor 621, 623, 625 may output power inputted from the battery 601 to a regulator 622, 624, 626 which may regulate the input power and output the regulated power to the AP 630. According to embodiments, the number of regulators may be one for each sub power supply device (for example, a PMIC) or may be implemented in plural number. The number of regulators may be set according to the purpose of the power supply device and one of ordinary skill in the art would understand that the number of regulators is not limited.

According to an embodiment, the power control device 610 may include a calculation module 611, a memory 612, and a control circuit 613, and may generate a control signal for controlling at least one of hardware and an application or controlling the power value outputted to the hardware, based on the power value received from the at least one sensor 621, 623, 625. In the following embodiments, a process of generating the control signal in the power control device 610 will be described in more detail.

When an operating time is designated, the calculation module 611 may measure current power remaining in the battery 601 and may calculate a power threshold indicating an amount of power that can be consumed in the electronic device 600 during the designated operating time, based on the designated operating time and the measured remaining amount of power. According to embodiments, the calculated power threshold may be stored in the memory 612.

According to embodiments, the calculation module 611 may perform a calculating operation to compare at least one of the power values received from the at least one sensor 621, 623, 625 and the power threshold stored in the memory 612. The calculation module 611 may receive a current value and a voltage value from the at least one sensor 621, 623, 625, and may calculate the power value based on the current value and the voltage value. The result of the calculating may be stored in the memory 621, and may be outputted to the control circuit 613. For example, when excessive power that is greater than or equal to the power threshold is applied to the AP 630, the electronic device 600 may not be operated during the pre-set operating time. Accordingly, the calculation module 611 may output the result of the calculating to the control circuit 613 such that the power of the electronic device 600 is controlled.

According to an embodiment, the control circuit 613 may generate a control signal for controlling at least one of hardware or an application or controlling a power value outputted to the AP 630 from the AP power supply device 620, based on the result of the calculating. The control circuit 613 may output the generated control signal to the AP power supply device 620. In response to the received control signal, the AP power supply device 620 may reduce the power value which is outputted to the AP 630 from the AP power supply device 620. For example, the AP power supply device 620 may reduce the outputted power value by controlling the operation of the at least one regulator 622, 624, 626. Accordingly, excessive power can be prevented from being applied to the AP 630. In another example, the control circuit 613 may output the control signal to the AP 630. The AP 630 may limit a function of a running application in response to the received control signal, and accordingly, may require a relatively smaller power value. According to an embodiment, the power control device 610 may generate the control signal based on the current value inputted to the sub power supply device 620.

The power control device 610 may control the power with respect to the CP power supply device 640, the display power supply device 660, and the camera power supply device 680 in a similar manner to the embodiment of the AP power supply device 620. For example, the power control device 610 may receive power values from power sensors 641, 643, 661, 663, 681 and may generate a control signal for controlling the power value outputted from the sub power supply device by controlling at least one of the regulators 642, 644, 662, 664, 682.

In the above-described embodiments, the process of generating a control signal using a power value inputted to a single piece of hardware and a corresponding sub power supply device has been described. According to embodiments, the power control device 610 may generate a control signal using a power value inputted to the entirety of the sub power supply devices 620, 640, 660, 680.

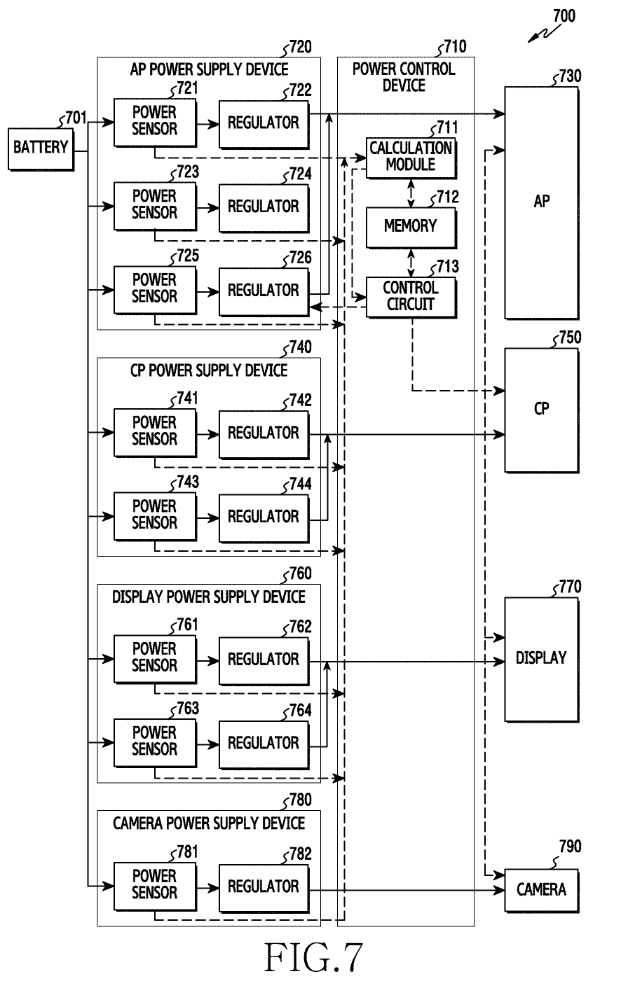

FIG. 7 illustrates a view showing a configuration of an electronic device 700 according to embodiments of the present disclosure. According to an embodiment, the electronic device 700 may be the electronic device 101, the electronic device 201, or the electronic device 400.

In the embodiment of FIG. 7, paths for transferring power are expressed by solid lines and paths for transferring signals or information are expressed by dashed lines for convenience of explanation.

As shown in FIG. 7, the electronic device 700 may include a battery 701, a power control device 710, an AP power supply device 720, an AP 730, a CP power supply device 740, a CP 750, a display power supply device 760, a display 770, a camera power supply device 780, and a camera 790. In FIG. 7, the electronic device 700 includes the AP 730, the CP 750, the display 770, and the camera 790 as hardware to which the electronic device 700 provides power, but one of ordinary skill in the art would understand that this is merely an example. Since the elements in FIG. 7 are operated similarly to the elements of FIG. 6 having the same names, a detailed description regarding some of the elements is omitted.

Compared with the embodiment of FIG. 6, the embodiment of FIG. 7 may include the power control device 710 which is disposed between the sub power supply devices 720, 740, 760, 780 and the hardware 730, 750, 770, 790. More specifically, the power control device 710 may obtain a power value which is inputted to the AP power supply device 720 from each of power sensors 721, 723, 725 of the AP power supply device 720. A calculation module 711 of the power control device 710 may compare the sensed power value and a power threshold which is calculated and stored in a memory 712. According to embodiments, a control circuit 713 may generate a control signal for controlling at least one of the hardware or an application based on the result of the comparing, may output the control signal to a regulator 726, which may regulate output power using the received control signal, may output the control signal to the plurality of regulators 722, 724, 726, 742, 744, 762, 764, 782, and may output the control signal to the AP 730.

The AP 730 may adjust a clock of a processor using the received control signal. In the embodiment, the power control device 710 may be disposed between the sub power supply devices 720, 740, 760, 780 and the hardware, but the location of the power control device 710 is not limited thereto. In addition, the power control device 710 may control the other sub power supply devices 740, 760, 780 or various pieces of hardware 750, 770, 790 as well as the regulator 726.

The following are aspects according to embodiments of the present disclosure, as described above. An electronic device may include a housing, a battery disposed inside the housing, a battery charging device electrically connected with the inside of the battery, a plurality of internal devices disposed inside the housing, at least one power control device disposed inside the housing and electrically connected with the internal devices and the battery to monitor a power value which is provided to the internal devices or consumed in the internal devices, a processor electrically connected with the power control device; and a memory electrically connected with the processor. When being executed, the memory may store instructions to receive, by the processor or the power control device, an input for designating an operating time during which the electronic device can be operated without being charged, and to change a power consumption value of the internal device when the power value consumed in the internal devices is greater than or equal to a threshold related to the designated operating time.

The instructions may be to measure, by the processor or the power control device, a remaining amount of power of the battery in response to the operating time being designated, and to calculate the threshold based on the operating time and the remaining amount of power of the battery.

The electronic device may further include a sensor configured to sense a power consumption value of the internal devices.

The sensor may be configured to sense at least one of a power value which is inputted to a PMIC or a power value which is outputted from the PMIC.

The instructions may be to output, by the processor or the power control device, notification information related to at least one of running of an application which consumes power more than the threshold or controlling of the running application.

The instructions may be to change, by the processor or the power control device, the power consumption value of the internal devices by controlling at least one of an operation of the internal device or an operation of a running application.

The instructions may be to control, by the processor or the power control device, an operation of at least one internal device or at least one running application based on priority.

The instructions may be to generate, by the processor or the power control device, a control signal for at least one of at least one internal device or a PMIC such that the power consumption value of the internal device is changed.

The instructions may be to re-calculate, by the processor or the power control device, the threshold in response to a situation in which battery consumption is changed being detected.

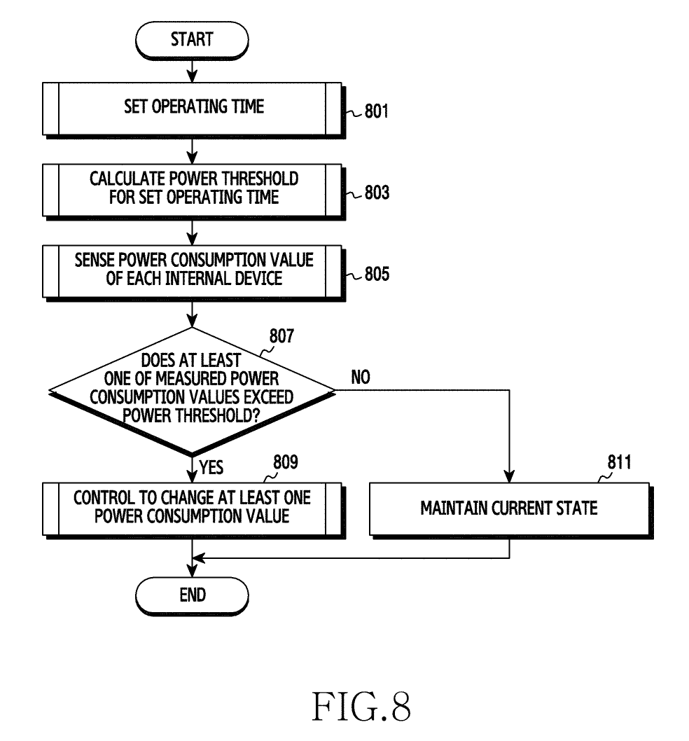

FIG. 8 is a flowchart showing an operation of performing a method for managing power in the electronic device 400 according to embodiments of the present disclosure.

In step 801, the electronic device 400 may set an operating time. According to embodiments, the operating time may be a time during which the electronic device 400 should be operated without charging the battery. For example, when the operating time is set, the electronic device 400 may manage power such that the electronic device 400 can be operated during the operating time.

In step 803, the electronic device 400 may calculate a power threshold for the set operating time. According to an embodiment, the power threshold may be a threshold on an amount of power which can be consumed in the electronic device during the operating time or a pre-designated time interval (for example, an amount of power consumed per hour). For example, when the operating time is set to 5 hours and the power threshold is 4000 mV, the electronic device 400 cannot consume power exceeding 4000 mV during the 5 hours. In another example, when the operating time is set to 5 hours and the power threshold is 4000 mV, the electronic device 400 cannot consume power exceeding 4000 mW every hour during the 5 hours.

According to embodiments, the electronic device 400 may include at least one power supply device (for example, a PMIC). When the electronic device 400 includes a plurality of power supply devices, the electronic device 400 may calculate a power threshold for each of the power supply devices. The electronic device 400 may set power thresholds having the same values or different values for the power supply devices.

In step 805, the electronic device 400 may sense a power consumption value of each of internal devices configured in the electronic device 400, or of the power supply device 420. According to an embodiment, the electronic device 400 may sense a power value which is inputted to each of the PMICs or a power value which is outputted to each of the internal devices from each of the PMICs.

In step 807, the electronic device 400 may determine whether at least one of the measured power consumption values exceed the power threshold. For example, the electronic device 400 may compare the measured power consumption value and the stored power threshold.

In step 807, when at least one of the measured power consumption values does not exceed the power threshold, the electronic device 400 may maintain a current state in step 811. According to an embodiment, the electronic device 400 may not control the power consumed in the power supply device and maintain the current state.

When at least one of the measured power consumption value exceeds the power threshold in step 807, the electronic device 400 may control such that at least one power consumption value is changed in step 809. According to an embodiment, the electronic device 400 may generate a control signal for changing the power consumption value for at least one of the processor or the power supply device. In certain examples, the electronic device 400 may adjust a clock of at least one internal device so as to change at least one power consumption value, or may stop the operation of either at least one running application which consumes power more than the power threshold, or at least one internal device which is being operated.

According to embodiments, at least one of steps 801 to 811 may be omitted.

While performing at least one of operations 801 to 811, the electronic device 400 may re-calculate the power threshold and control such that the electronic device 400 can be operated during the designated operating time. For example, the electronic device 400 may re-calculate the power threshold based on at least one of a pre-designated timer interval, and a point of time at which an application is run or finishes.

According to embodiments, the electronic device 400 can consume power based on the power threshold for the operating time and thereby effectively use the battery. Therefore, the related-art problem in which the operation of the electronic device is limited by a remaining amount of power in the battery can be solved. For example, when the remaining amount of power of the battery is 10% and a camera function is operated without setting an operating time, the electronic device 400 may not limit a flash function.

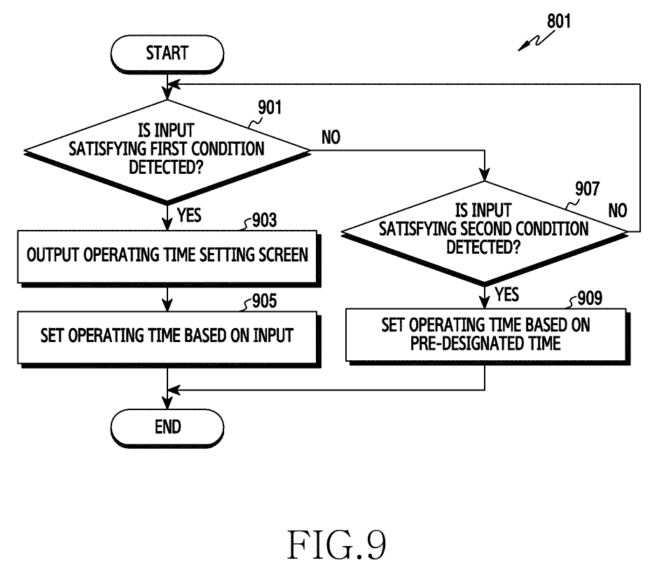

FIG. 9 is a flowchart showing an operation of performing a method for setting an operating time in the electronic device 400 according to embodiments of the present disclosure. The method for setting the operating time in FIG. 9 may be a detailed operation of step 801 of FIG. 8.

In step 901, the electronic device 400 may determine whether an input satisfying a first condition is detected. According to embodiments, the first condition may be related to an input for outputting a setting screen to set an operating time, and the input satisfying the first condition may include at least one of a voice input, a key input, and a gesture input.

When the input satisfying the first condition is detected in step 901, the electronic device 400 may output an operating time setting screen on the screen in step 903.

In step 905, the electronic device 400 may set the operating time based on an input. For example, the electronic device 400 may set at least one of date information, hour information, and minute information based on an input.

When an input satisfying the first condition is not detected in step 901, the electronic device 400 may determine whether an input satisfying a second condition is detected in step 907. According to embodiments, the second condition may be related to an input for setting a pre-designated time (default value) as the operating time or an input for setting a specific mode, or to a situation in which the operating time setting operation is not performed and the operating time is automatically set.

For example, the electronic device 400 may detect, as the input satisfying the second condition, an input which is configured to set a pre-designated time, such as 5 hours, as the operating time. According to an embodiment, the input for setting the specific mode may be related to an emergency situation. For example, the electronic device 400 may detect an input which is configured to enter an emergency mode in which a pre-designated function such as generating a siren, sharing a location, or transmitting a rescue message, can be executed, as the input satisfying the second condition. In another example, the electronic device 400 may detect reception of a message such as a text, notifying the occurrence of a disaster as the input satisfying the second condition.

When an input satisfying the second condition is not detected in step 907, the electronic device 400 may return to step 901.

When the input satisfying the second condition is detected in step 907, the electronic device 400 may automatically set the operating time based on the pre-designated time in step 909. For example, the electronic device 400 may set the pre-designated time as the operating time regardless of a user's input.

According to embodiments, the electronic device 400 may set the operating time and then calculate a power threshold based on the set operating time. For example, the electronic device 400 may perform an operation related to step 803 of FIG. 8.

According to embodiments, at least one of steps 901 to 907 may be omitted.

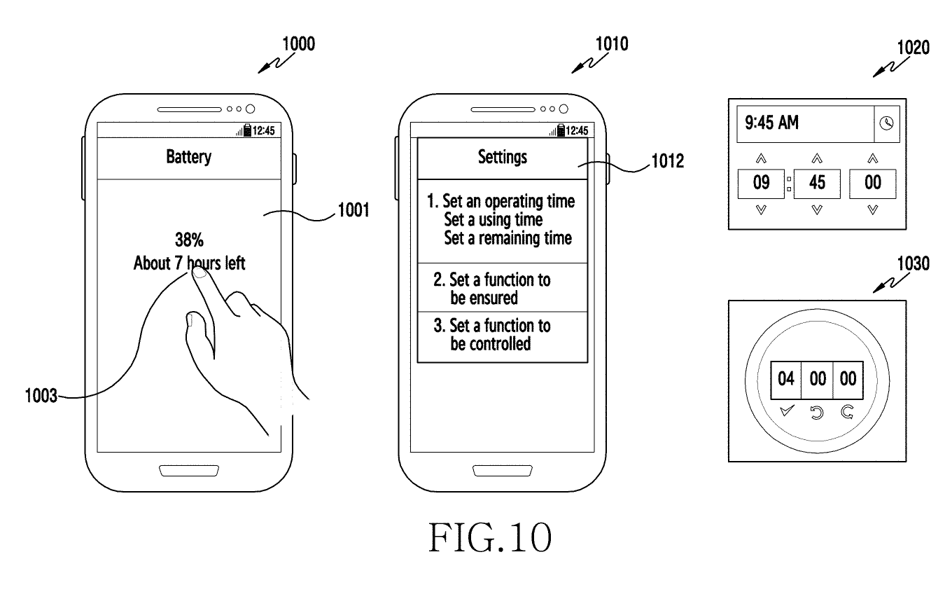

FIG. 10 illustrates a view showing an operating time setting screen according to embodiments of the present disclosure.

According to embodiments, the operating time setting screen may be outputted based on a user's input. For example, in a state 1000 in which a screen 1001 displaying battery using information is outputted, the electronic device 400 may output an operating time setting screen 1012 based on a touch input 1003 (1010).

According to embodiments, the operating time setting screen 1012 may include an item for setting a using time and an item for setting a remaining time. The user may set such that the operation of the electronic device 400 can be ensured until a designated time such as 9:45 A.M. is reached (1020). According to another embodiment, the user may set such that the operation of the electronic device 400 can be ensured for a remaining time such as 4 hours from now (1030).

According to embodiments, on the operating time setting screen 1012, the user may set at least one of a function the operation of which should be ensured or a function which should be limited when managing power. For example, the function the operation of which should be ensured may be a game, in which case hardware related to the game may not be controlled when power is managed. To the contrary, when the function which should be controlled is a game, power or at least some function may be controlled based on hardware related to the game when power is managed.

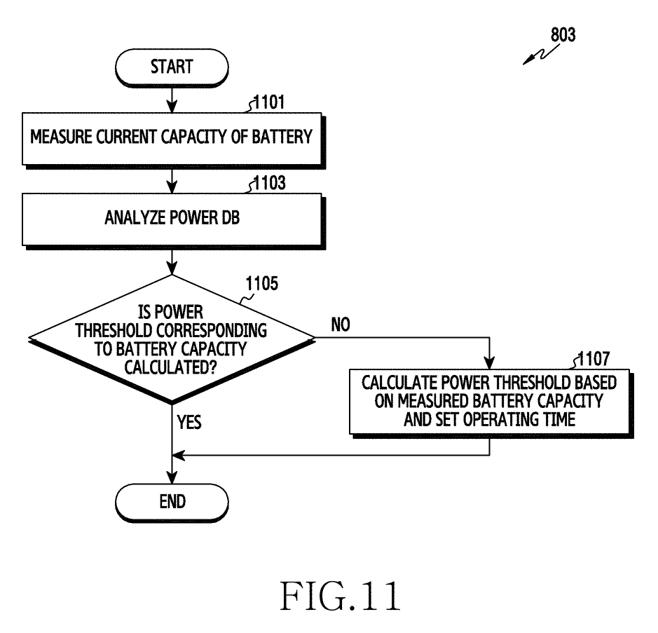

FIG. 11 is a flowchart showing an operation of performing a method for calculating a power threshold in the electronic device 400 according to embodiments of the present disclosure. The operation of calculating the power threshold in FIG. 11 may be a detailed operation of step 803 of FIG. 8.

In step 1101, the electronic device 400 may measure a current capacity of the battery 401, such as a remaining capacity of the battery in response to an operating time being set.

In step 1103, the electronic device 400 may analyze a power database (DB). According to embodiments, the power DB may have power thresholds pre-defined, and the remaining capacity of the battery may be divided into a plurality of levels for which power thresholds may be designated.

In step 1105, the electronic device 400 may determine whether a power threshold corresponding to the remaining capacity of the battery is calculated. For example, the electronic device 400 may determine whether there exists in the power DB a power threshold corresponding to the measured remaining capacity of the battery.

When the power threshold corresponding to the remaining capacity of the battery is calculated in step 1105, the electronic device 400 may perform an operation of sensing power consumption. For example, an operation related to step 805 may be performed.

When the power threshold corresponding to the remaining capacity of the battery is not calculated in step 1105, the electronic device 400 may calculate a power threshold based on the measured remaining capacity of the battery and the set operating time in step 1107. According to an embodiment, the electronic device 400 may calculate the power threshold based on a calculation method which divides the measured remaining capacity of the battery by the operating time, such as in Equation (1) presented below:

Power Threshold=Remaining Capacity of Battery at Set Time (W)/Operating Time (T) . . . (1)

When the power threshold corresponding to the remaining capacity of the battery is calculated in step 1107, the electronic device 400 may proceed to performing an operation of sensing power consumption.

According to embodiments, at least one of operations 1101 to 1107 may be omitted.

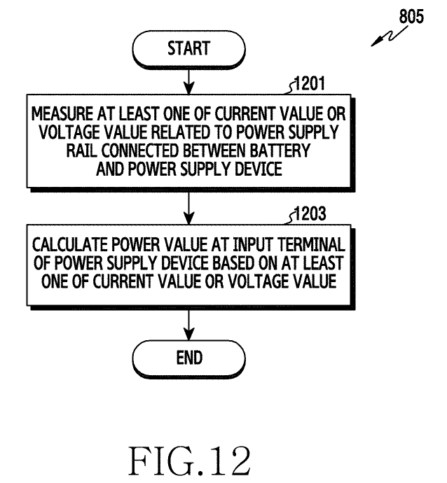

FIG. 12 is a flowchart showing an operation of performing a method for sensing a power consumption value in the electronic device 400 according to embodiments of the present disclosure. The method for sensing the power consumption value in FIG. 12 may be a detailed operation of step 805 of FIG. 8.

In step 1201, the electronic device 400 may measure at least one of a current value or a voltage value related to a power supply rail connected between the battery 401 and the power supply device 420, such as through the power sensor 422 which is provided inside or outside the power supply device 420.

In step 1203, the electronic device 400 may calculate a power value at an input terminal of the power supply device based on at least one of the measured current value or voltage value.

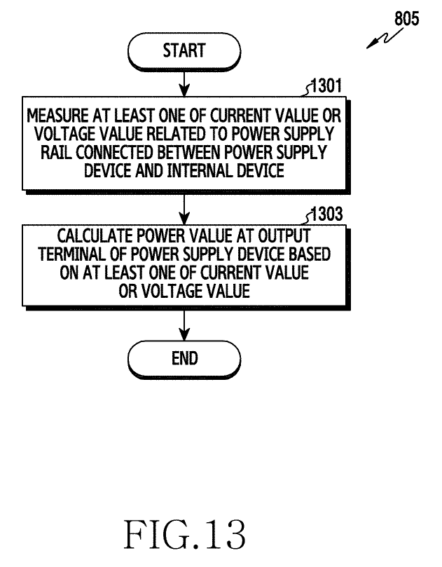

FIG. 13 is a flowchart showing an operation of performing a method for sensing a power consumption value in the electronic device 400 according to embodiments of the present disclosure. The method for sensing the power consumption value in FIG. 13 may be a detailed operation of step 805 of FIG. 8.

In step 1301, the electronic device 400 may measure at least one of a current value or a voltage value related to each power supply rail connected between the power supply device 420 and the internal device 430, such as through the power sensor 422 which is provided inside or outside the power supply device 420.

In step 1303, the electronic device 400 may calculate a power value at an output terminal of the power supply device 420 based on at least one of the measured current value or voltage value.

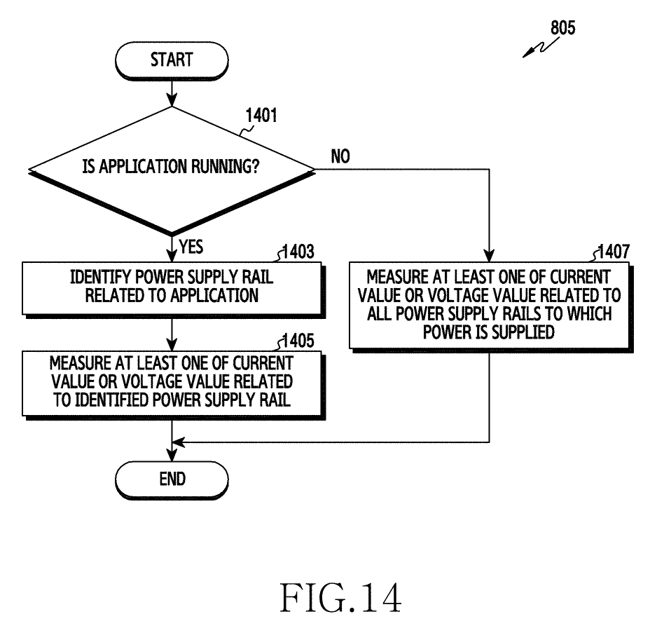

FIG. 14 is a flowchart showing an operation of performing a method for sensing a power consumption value in the electronic device 400 according to embodiments of the present disclosure. The method for sensing the power consumption value in FIG. 14 may be a detailed operation of step 805 of FIG. 8.

In step 1401, the electronic device 400 may determine whether at least one application is running or being operated.

When it is determined that the application is not running in step 1401, the electronic device 400 may measure at least one of current values or power values related to all power supply rails to which power is supplied in step 1407. For example, when the application is neither run nor operated, standby power may be supplied to the inside of the electronic device 400. In this case, the electronic device 400 may measure at least one of current values or power values related to all power supply rails to which the standby power is supplied.

When the running or operation of the application is detected in step 1401, the electronic device 400 may identify a power supply rail which is related to the application which is running or being operated in step 1403. According to an embodiment, the electronic device 400 may supply power only to some power supply rails related to the application from among the power supply rails of the electronic device 400 according to the running or operation of the application, in which case the electronic device 400 may identify a power supply rail to which power is supplied. According to another embodiment, power may be supplied to all of the power supply rails of the electronic device 400 according to the running or operation of the application, in which case the electronic device 400 may identify a power supply rail to which power more than a threshold is supplied by the running or operation of the application. The electronic device 400 may identify hardware which is supplied with power and is driven based on the running or operation of the application. For example, when a game application which is controlled by a sensor and a user input is run, the electronic device 400 may identify a display, a GPU, a keypad, or a sensor to which power is supplied.

In step 1405, the electronic device 400 may measure at least one of a current value or a voltage value related to the identified power supply rail. For example, the electronic device 400 may measure a current value or a voltage value related to at least some of the rails to which power is supplied.

After measuring the current value or voltage value related to the entirety of the power supply rails or at least some of the power supply rails, the electronic device 400 may calculate a power value and compare the power value and a pre-stored power threshold. For example, the electronic device 400 may perform an operation related to step 807.

According to embodiments, at least one of steps 1401 to 1407 may be omitted.

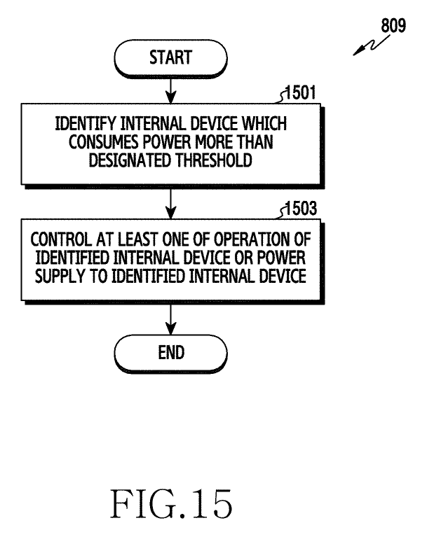

FIG. 15 is a flowchart showing an operation of performing a method for controlling to change a power consumption value in the electronic device 400 according to embodiments of the present disclosure. The method for controlling to change the power consumption value may be a detailed operation of step 809 of FIG. 8.

In step 1501, the electronic device 400 may identify an internal device which consumes power more than a designated threshold, which may be a pre-stored power threshold. In addition, the internal device which consumes power more than the designated threshold may be an internal device which consumes the greatest power from among the internal devices of the electronic device.

According to an embodiment, in step 1503, the electronic device 400 may control at least one of the operation of the identified internal device or power supply to the identified internal device. In certain examples, when the internal device which consumes power more than the designated threshold is a processor, the electronic device 400 may adjust the clock of the processor. When the internal device which consumes power more than the designated threshold value is a camera, the electronic device 400 may stop the flash operation of the camera. The electronic device 400 may adjust at least part of the power provided to the internal device 430 by controlling at least one regulator of the power supply device 420 which supplies power received from the battery 401 to the internal device 430.

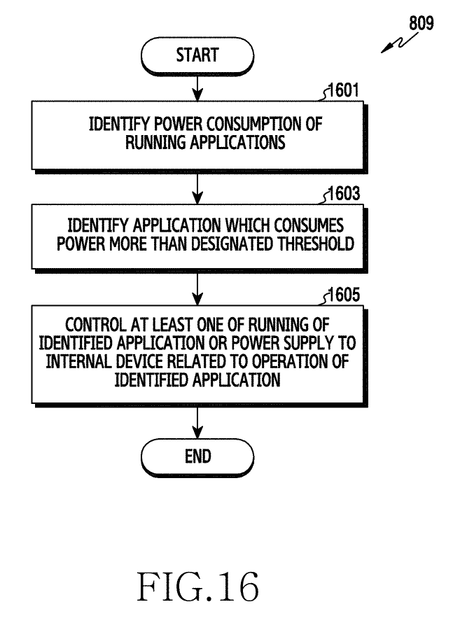

FIG. 16 is a flowchart showing an operation of performing a method for controlling to change a power consumption value in the electronic device 400 according to embodiments of the present disclosure. The method for controlling to change the power consumption value in FIG. 16 may be a detailed operation of step 809 of FIG. 8.

In step 1601, the electronic device 400 may identify power consumption of running applications.

In step 1603, the electronic device 400 may identify an application which consumes more than a designated threshold from among the running applications.

In step 1605, the electronic device 400 may limit running of the identified application or at least one function, or may control power supply to at least one internal device related to the operation of the identified application. For example, the electronic device 400 may control to reduce the screen brightness of the running application.

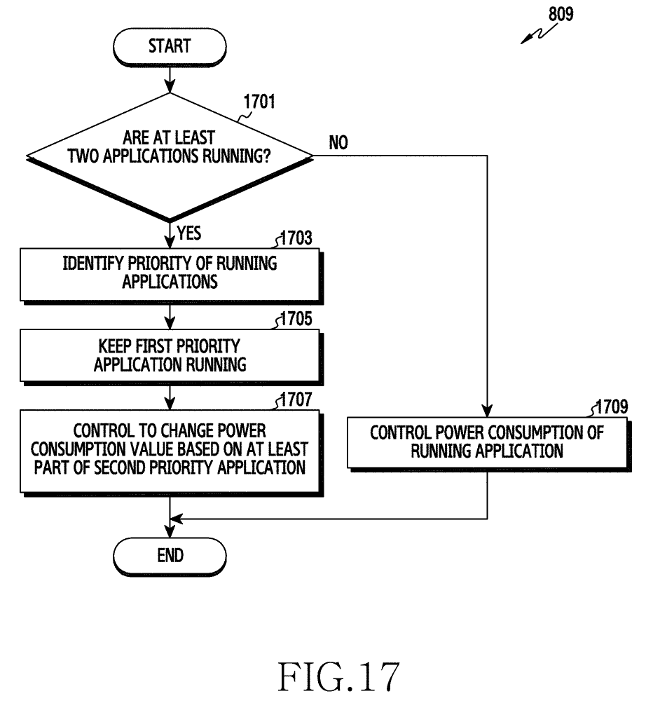

FIG. 17 is a flowchart showing an operation of performing a method for controlling to change a power consumption value in the electronic device 400 according to embodiments of the present disclosure. The method for controlling to change the power consumption value in FIG. 17 may be a detailed operation of step 809 of FIG. 8.

In step 1701, the electronic device 400 may determine whether at least two applications are running

When it is determined that at least two applications are not running in step 1701, such as when determining that a single application is running, the electronic device 400 may control power consumption of the running application in step 1709. According to an embodiment, the electronic device 400 may perform operations related to FIG. 15 or 16, and, when there is no running application, may perform operations related to FIG. 14.

When it is determined that at least two applications are running in step 1701, the electronic device 400 may identify priority regarding the running applications or at least one function of the applications in step 1703. The priority may be related to applications the running or operation of which should be ensured. According to embodiments, the priority may be designated by the user according to an attribute of an application. For example, a security-related application such as a finance application may be assigned higher priority than other applications.

In step 1705, the electronic device 400 may keep a first priority application running For example, the electronic device 400 may maintain power supplied to an internal device related to the first priority application.

In step 1707, the electronic device 400 may control to change a power consumption value based on at least part of a second priority application. According to embodiments, the electronic device 400 may stop the second priority application or limit at least some functions, may control power supply to an internal device related to the second priority application, and may differently control a power consumption value of at least one running application based on the priority. For example, the electronic device 400 may control such that an amount of power supplied to the internal device related to the first priority application is greater than the amount of power supplied to the internal device related to the second priority application.

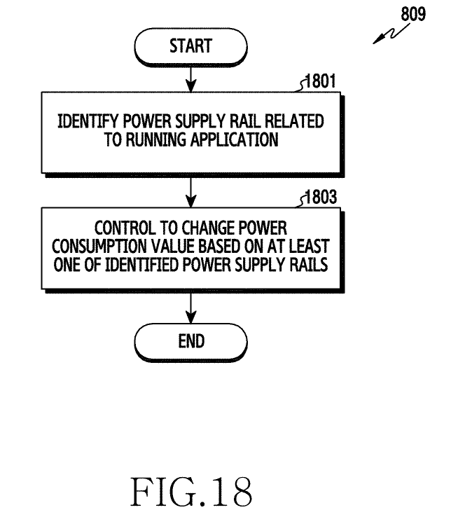

FIG. 18 is a flowchart showing an operation of performing a method for controlling to change a power consumption value in the electronic device 400 according to embodiments of the present disclosure. The method for controlling to change the power consumption value in FIG. 18 may be a detailed operation of step 809 of FIG. 8.

In step 1801, the electronic device 400 may identify a power supply rail related to a running application. For example, when a game application which is controlled by a sensor and a user input is running, the electronic device 400 may identify a power supply rail for supplying power to a display, a GPU, a key pad, or a sensor.

In step 1803, the electronic device 400 may control to change a power consumption value based on at least one of the identified power supply rails. According to various embodiment, the electronic device 400 may reduce the power consumption value of the electronic device 400 by reducing power supplied to the at least one rail.

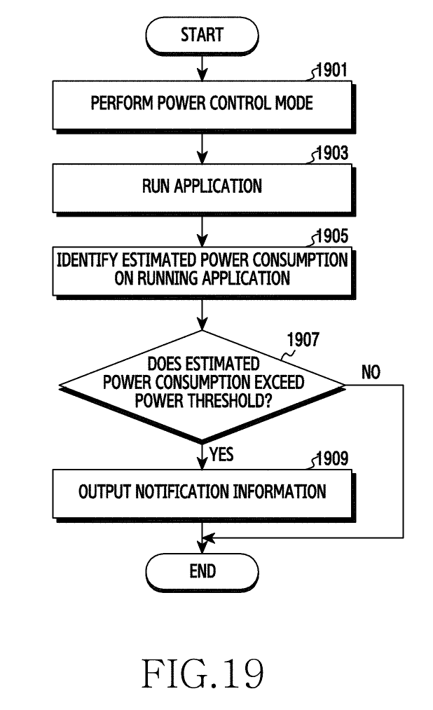

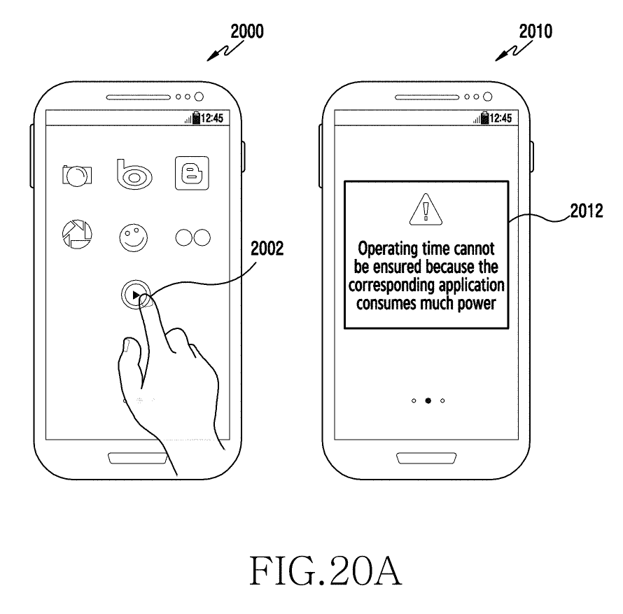

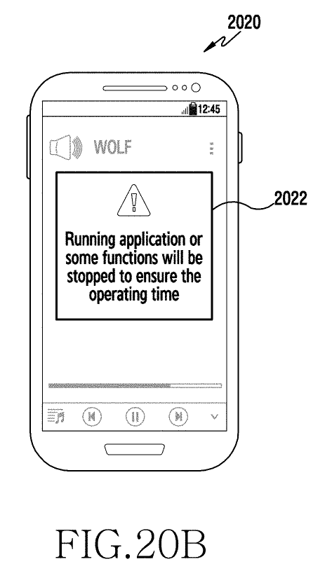

FIG. 19 is a flowchart showing an operation of performing a method for controlling power in the electronic device 400 according to embodiments of the present disclosure. In addition, FIGS. 20A and 20B illustrate views showing an operation of controlling running of an application which consumes much power in the electronic device 400 according to embodiments of the present disclosure.

In step 1901, the electronic device 400 may perform a power control mode, which may be related to at least some of steps 801 to 811 of FIG. 8.

In step 1903, the electronic device 400 may run at least one application. As shown in FIG. 20A, the electronic device 400 may run an application corresponding to an input 2002 while executing the control mode (2000).

In step 1905, the electronic device 400 may identify estimated power consumption on the running application. According to an embodiment, the electronic device 400 may pre-store estimated power consumption on an application which can be run, and calculate estimated power consumption on an application corresponding to an input.

In step 1907, the electronic device 400 may determine whether the estimated power consumption exceeds a power threshold.

When the estimated power consumption does not exceed the power threshold in step 1907, the electronic device 400 may run the application.

When the estimated power consumption exceeds the power threshold in step 1907, the electronic device 400 may output notification information in step 1909. According to an embodiment, as shown in FIG. 20A, the electronic device 400 may output notification information 2012 indicating that an application requiring high power consumption is running (2010). According to another embodiment, as shown in FIG. 20B, the electronic device 400 may output notification information 2022 indicating that the running of the application or the function of the running application will be limited to ensure the operating time, due to power consumption of the currently running application (2020).

According to embodiments, at least one of steps 1901 to 1909 may be omitted.

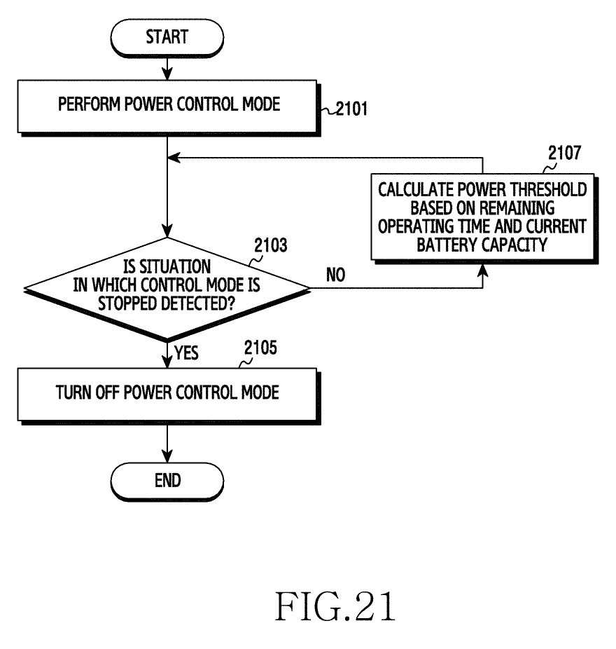

FIG. 21 is a flowchart showing an operation of performing a method for controlling power in the electronic device 400 according to embodiments of the present disclosure.

In step 2101, the electronic device 400 may perform a power control mode. According to embodiments, the power control mode may be related to some of operations 801 to 811 of FIG. 8.

In step 2103, the electronic device 400 may determine whether a situation in which the power control mode is stopped is detected. Such a situation may be when the electronic device 400 can be sufficiently operated for longer than a designated operating time, such as when the battery is replaced, a charging adaptor is connected, or power is supplied by an external battery. In another example, the situation in which the power control mode is stopped may be when the user inputs an input for finishing the power control mode or the designated operating time elapses.

When the situation in which the power control mode is stopped is detected in step 2103, the electronic device 400 may turn off the power control mode in step 2105.

When the situation in which the power control mode is stopped is not detected in step 2103, the electronic device 400 may calculate a power threshold based on the remaining operating time and the remaining capacity of the battery in step 2107.

According to an embodiment, the electronic device 400 may re-calculate the power threshold in response to a situation in which the amount of power consumption of the battery is changed (for example, a situation in which the electronic device which has been operated in a standby mode, in which less power is consumed, during a predetermined time runs a game which requires much power consumption), and may control such that the electronic device 400 can be operated during the designated operating time. According to another embodiment, the electronic device 400 may update the power threshold when the operating time elapses, such as based on a pre-designated time interval (for example, 10 minutes to 1 hour). In another example, the electronic device 400 may update the power threshold based on a point of time at which a new application is run or a point of time at which the running application finishes.

According to embodiments, at least one of operations 2101 to 2107 may be omitted.

The following are aspects according to embodiments of the present disclosure, as described above. A method for operating of an electronic device may include receiving an input of an operating time during which the electronic device can be operated without being charged, calculating a power threshold related to the operating time based on the operating time and a remaining amount of power of a battery, monitoring a power value which is consumed in at least one internal device of the electronic device, and, when the power value consumed in the at least one internal device of the electronic device is greater than or equal to the power threshold, controlling a power consumption value by controlling the at least one internal device.

Calculating the power threshold related to the operating time may include calculating the power threshold related to each of the internal devices.

Monitoring the power value may include sensing a power consumption value of the internal device using at least one sensor.

Monitoring the power value may include sensing at least one of a power value which is inputted to a PMIC or a power value which is outputted form the PMIC.

According to embodiments, the controlling the power consumption value may include outputting notification information related to at least one of running of an application which consumes power more than the power threshold and controlling of the running application.

Controlling the power consumption value may include controlling the power consumption value by controlling at least one of an operation of the internal device or an operation of a running application.

Controlling the power consumption value may include controlling an operation of at least one internal device or at least one running application based on priority.

Calculating the power threshold related to the operating time may include calculating the power threshold related to the operating time which is designated based on at least one of a time set by an input or a pre-defined time (default value).

Controlling the power consumption value may include generating a control signal for at least one of at least one internal device or a PMIC such that the power consumption value of the internal device is changed.

Controlling the power consumption value may include re-calculating the power threshold in response to a situation in which battery consumption is changed being detected.

The electronic device for managing power and the method for controlling thereof according to embodiments control power consumption of the electronic device based on at least one of a power value which is inputted to or outputted from the PMIC, such that a pre-designated operating time of the electronic device can be ensured.

Furthermore, since power is consumed based on the power threshold regarding the operating time regardless of a battery charging state, and the battery can be efficiently used, the related-art problem in which the operation of the electronic device is limited by the battery charging state can be solved.

The term “module” used in the embodiments of the present disclosure refers to a unit including one of hardware, software, and firmware, or a combination of at least two of the same. For example, the “module” may be used interchangeably with terms such as “unit,” “logic,” “logical block,” “component” or “circuit.” The “module” may be a minimum unit of all or part of an integrally configured component. The “module” may be a minimum unit that performs one or more functions, and may be implemented mechanically or electronically. For example, the “module” may include at least one of an application-specific integrated circuit (ASIC) chip, field-programmable gate arrays (FPGAs), and a programmable logic device, which perform any operation that is already well known or will be developed in the future.

At least part of the apparatus or method according to embodiments may be implemented by using instructions stored in computer-readable storage media in the form of a program module. When the instructions are executed by a processor, the one or more processors may perform a function corresponding to the instructions. The computer-readable storage media may be the memory 130, for example.

Examples of the computer-readable recording media include hard disks, floppy disks and magnetic media (for example, magnetic tapes), optical media (for example, a compact disc read only memory (CD-ROM) and a digital versatile disc (DVD), magneto-optical media such as floptical disks, and hardware devices such as a read only memory (ROM), a random access memory (RAM) and a flash memory. Examples of the program commands include machine language codes created by a compiler, and high-level language codes that can be executed by a computer by using an interpreter. The above-described hardware devices may be configured to operate as one or more software modules for performing operations of embodiments, and vice versa.

A module or program module according to embodiments of the present disclosure may include one or more of the above-described elements, may omit some elements, or may further include additional elements. The operations performed by the module, the program module, or the other elements according to embodiments of the present disclosure may be performed serially, in parallel, repeatedly, or heuristically. In addition, some operations may be performed in different order or may be omitted, and an additional operation may be added.

While the present disclosure has been shown and described with reference to certain embodiments thereof, it will be apparent to those skilled in the art that the present disclosure is not limited to these embodiments, and various changes in form and details may be made therein without departing from the spirit and scope of the present disclosure as defined by the appended claims.

What is claimed is:

1. An electronic device comprising:
a housing;
a battery disposed inside the housing;
a battery charging device electrically connected to inside of the battery;
a plurality of internal devices disposed inside the housing;
at least one power control device disposed inside the housing and electrically connected with the internal devices and the battery, wherein the at least one power control device monitors a power value which is provided to the internal devices or consumed in the internal devices;
a processor electrically connected with the power control device; and
a memory electrically connected with the processor,
wherein, when being executed, the memory stores instructions that cause the processor or the power control device to receive an input for designating an operating time during which the electronic device can be operated without being charged, and to change a power consumption value of the internal device when the power value consumed in the internal devices is greater than or equal to a threshold related to the designated operating time.

2. The electronic device of claim 1, wherein the instructions cause the processor or the power control device to measure a remaining amount of power of the battery in response to the operating time being designated, and to calculate the threshold based on the operating time and the remaining amount of power of the battery.

3. The electronic device of claim 2, wherein the instructions cause the processor or the power control device to re-calculate the threshold in response to when a battery consumption change is detected.

4. The electronic device of claim 1, further comprising a sensor configured to sense the power consumption value of the internal devices.

5. The electronic device of claim 4, wherein the sensor is further configured to sense at least one of a power value which is inputted to or outputted from a power management integrated circuit.

6. The electronic device of claim 1, wherein the instructions cause the processor or the power control device to output notification information related to at least one of running of an application which consumes power more than the threshold or controlling of the running application.

7. The electronic device of claim 1, wherein the instructions cause the processor or the power control device to change the power consumption value of the internal devices by controlling at least one of an operation of the internal device or an operation of a running application.

8. The electronic device of claim 7, wherein the instructions cause the processor or the power control device to control an operation of at least one internal device or at least one running application based on priority.

9. The electronic device of claim 1, wherein the instructions cause the processor or the power control device to generate a control signal for at least one of at least one internal device or a power management integrated circuit such that the power consumption value of the internal device is changed.

10. A method for operating of an electronic device, the method comprising:
receiving an input of an operating time during which the electronic device can be operated without being charged;
calculating a power threshold related to the operating time based on the operating time and a remaining amount of power of a battery electrically connected to the electronic device;
monitoring a power value which is consumed in at least one internal device of the electronic device; and
when the power value consumed in the at least one internal device of the electronic device is greater than or equal to the power threshold, controlling a power consumption value by controlling the at least one internal device.

11. The method of claim 10, wherein calculating the power threshold related to the operating time comprises calculating the power threshold related to each of the internal devices.

12. The method of claim 10, wherein monitoring the power value comprises sensing a power consumption value of the internal device using at least one sensor.

13. The method of claim 12, wherein monitoring the power value comprises sensing at least one of a power value which is inputted to or outputted from a power management integrated circuit (PMIC).

14. The method of claim 10, wherein controlling the power consumption value comprises outputting notification information related to at least one of running of an application which consumes power more than the power threshold and controlling of the running application.

15. The method of claim 10, wherein the power consumption value is controlled by controlling at least one of an operation of the internal device or of a running application.

16. The method of claim 15, wherein controlling the power consumption value comprises controlling an operation of at least one internal device or at least one running application based on priority.

17. The method of claim 10, wherein the calculated power threshold related to the operating time is designated based on at least one of a time set by an input or a default value.

18. The method of claim 10, wherein controlling the power consumption value comprises generating a control signal for at least one of at least one internal device or a power management integrated circuit such that the power consumption value of the internal device is changed.

19. The method of claim 10, wherein controlling the power consumption value comprises re-calculating the power threshold in response to when a battery consumption change is detected.

20. A non-transitory computer-readable recording medium which records a program for executing a method for operating of an electronic device, the method comprising:
receiving an input of an operating time during which the electronic device can be operated without being charged;
calculating a power threshold related to the operating time based on the operating time and a remaining amount of power of a battery electrically connected to the electronic device;
monitoring a power value which is consumed in at least one internal device of the electronic device; and
when the power value consumed in the at least one internal device of the electronic device is greater than or equal to the power threshold, controlling a power consumption value by controlling the at least one internal device.
